(19) United States
(12) Patent Application Publication
(10) Pub. No.: US 2012/0206090 A1
(43) Pub. Date: Aug. 16, 2012

(54) Charging device using magnets

(75) Inventors: Kim Hyun-Jun, Daejeon (KR); Youn Dae-Young, Seoul (KR); Jeong Seung-Ju, Daejeon (KR); Kim Jung Gyo, Daejeon (KR); Kim Hyo-Nam, Daejeon (KR)

(73) Assignee: SMART POWER SOLUTIONS, INC., Daejeon (KR)

(21) Appl. No.: 13/278,278

(22) Filed: Oct. 21, 2011

(30) Foreign Application Priority Data
Feb. 11, 2011 (KR) 10-2011-0012515

(51) Int. Cl. H02J 7/00; H01R 11/30

(52) U.S. Cl. 320/107; 439/39

(57) ABSTRACT

A charging device using magnets is disclosed. The charging device using magnets includes a sleeve and a charging pad. The sleeve includes a connector connected to the charging terminal of a mobile terminal, and a plurality of magnetic terminals connected to the connector. The charging pad includes magnetic electrodes which magnetically come into contact with the respective magnetic terminals of the sleeve, and supplies charging power to the magnetic terminals using the magnetic electrodes. The magnetic electrodes of the charging pad are configured such that magnetic forces are attenuated due to magnetic fields of coils or such that repulsive forces are generated between the magnetic electrodes of the charging pad and the magnetic terminals of the sleeve which come into contact with the magnetic electrodes.

### BACKGROUND OF THE INVENTION

1. Field of the Invention

The present invention relates to a charging device using magnets, which is used to charge a mobile terminal using magnetic electrodes or magnetic material electrodes.

2. Description of the Prior Art

Generally, mobile terminals, such as mobile phones, smart phones, and Personal Digital Assistants (PDAs), have been universally used due to excellent mobility and simple portability. Therefore, wired chargers for charging batteries of mobile terminals have been manufactured in different shapes depending on the shapes or standards of manufactured batteries.

Further, individual manufacturing companies manufacture various types of mobile terminals and various types of chargers which are suitable for the mobile terminals because of a tendency to improve the functions and to reduce the weights of such mobile terminals, thereby coinciding with the request of users.

Recently, with the development of technology, new types of chargers have been provided. A wireless charging method of charging a battery without electrical contact using a magnetic induction method has been used for such a new type of charger in order to solve the problems of the existing charging methods.

However, such a wireless charger has problems of complex design and high manufacturing cost.

### SUMMARY OF THE INVENTION

Accordingly, the present invention has been made keeping in mind the above problems occurring in the prior art, and an object of the present invention is to provide a charging device using magnets which can rapidly and conveniently charge a mobile terminal using a simple-structured charging manner in which magnetic electrodes or magnetic material electrodes are used.

The objects of the present invention are not limited to the above-described object, and objects which are not mentioned can be apparently understood by those skilled in the art based on the description below.

In order to accomplish the above object, the present invention provides a charging device using magnets, including: a sleeve including a connector connected to the charging terminal of a mobile terminal, and a plurality of magnetic terminals connected to the connector; and a charging pad including magnetic electrodes which magnetically come into contact with the respective magnetic terminals of the sleeve, and supplying charging power to the magnetic terminals using the magnetic electrodes.

In detail, the charging device may further include a plurality of communication terminals provided around the magnetic terminals of the sleeve; and a plurality of communication electrodes provided on the charging pad such that the communication electrodes correspond to the respective communication terminals.

The magnetic electrodes of the charging pad may be configured such that magnetic forces are attenuated due to the magnetic fields of coils or such that repulsive forces are generated between the magnetic electrodes of the charging pad and the magnetic terminals of the sleeve which come into contact with the magnetic electrodes.

The charging pad further includes a transformation unit for dropping the level of an externally applied common Alternating Current (AC) voltage to a desired level; and a rectifying unit for rectifying voltage output from the transformation unit to Direct Current (DC) voltage, and outputting the DC voltage to the magnetic electrodes. The charging pad further includes coils wound on respective magnetic electrodes, and configured to generate magnetic fields depending on current to be applied; an input unit configured to detect an operational instruction received from the outside or an approached human body, and to output a signal corresponding thereto; and a control unit configured to apply current to the coils during a set time based on the instruction received from the input unit such that magnetic forces of the magnetic electrodes are attenuated or repulsive forces are generated between the magnetic electrodes of the charging pad and the magnetic terminals of the sleeve.

The magnetic electrodes of the charging pad and the magnetic terminals of the sleeve, which are corresponding to the respective magnetic electrodes, are formed in a protruded and depressed configuration. The charging pad may further include subsidiary magnets which are coupled to the respective magnetic electrodes and configured to increase the magnetic forces of the magnetic electrodes. In order to accomplish the above object, the present invention provides another charging device using magnets including: a sleeve including a connector connected to the charging terminal of a mobile terminal, and a plurality of magnetic terminals connected to the connector; and a charging pad including magnetic material electrodes which magnetically come into contact with the respective magnetic terminals of the sleeve, and supplying charging power to the magnetic terminals using the magnetic material electrodes.

In particular, the charging device may further include magnets coupled to the magnetic material electrodes of the charging pad, and configured to apply magnetic forces to the magnetic material electrodes.

The charging pad may further include coils wound on the respective magnetic material electrodes, and configured to generate magnetic fields depending on current to be applied; an input unit configured to detect an operational instruction received from the outside or an approached human body, and to output a signal corresponding thereto; and a control unit configured to apply current to the coils for a set time based on the instruction received from the input unit, and to perform control such that the magnetic forces of the magnetic material electrodes are attenuated or repulsive forces are generated between the magnetic material electrodes of the charging pad and the magnetic terminals of the sleeve.

As described above, the present invention uses a simple-structured charging manner in which magnetic electrodes are used, thereby having advantages of rapidly charging a mobile terminal like an existing wired charger, and conveniently charging a mobile terminal like a wireless charger using a magnetic induction manner.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a view illustrating the appearance of a charging device using magnet electrodes according to an embodiment of the present invention;

FIG. 2 is a view illustrating the arrangement structure of magnetic terminals and electrodes according to the present invention;

FIGS. 3 and 4 are views illustrating the arrangement structure of terminals according to another embodiment of the present invention;

FIG. 5 is a diagram illustrating the detailed configuration of a charging pad according to an embodiment of the present invention;

FIG. 6 is a diagram illustrating the detailed structure of an electrode according to another embodiment of the present invention; and

FIG. 7 is a view illustrating the appearance of a charging device using magnetic electrodes according to another embodiment of the present invention.

### DETAILED DESCRIPTION OF THE INVENTION

Embodiments of the present invention will be described in detail below with reference to attached drawings. Reference should now be made to the drawings, in which the same reference numerals are used throughout the different drawings to designate the same or similar components. Further, the detailed description of wellknown functions and configurations that may obscure the gist of the present invention will be omitted.

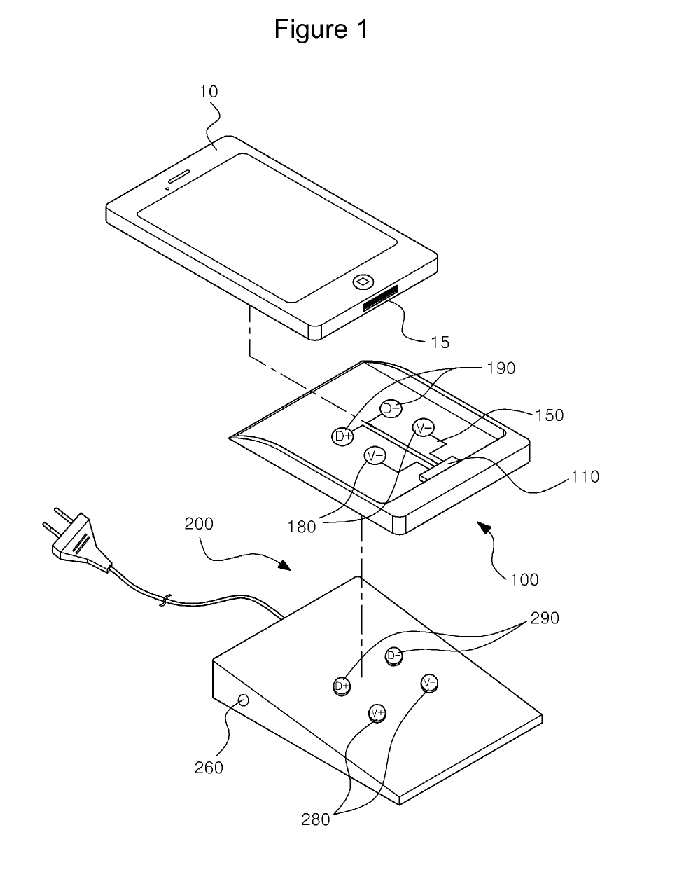

FIG. 1 is a view illustrating the appearance of a charging device using magnet electrodes according to an embodiment of the present invention. The charging device includes a sleeve 100 and a charging pad 200.

The sleeve 100 includes a connector 110 that is connected to the charging terminal 15 of a mobile terminal 10. A plurality of magnetic terminals 180 (V+ and V−) and communication terminals 190 (D+ and D−), which are electrically connected to the connector 110, are formed around the connector 110. The mobile terminal 10 is inserted into and mounted on the sleeve 100. When the mobile terminal 10 is mounted on the sleeve 100, connection is made in such a way that the charging terminal 15 of the mobile terminal 10 is inserted into the connector 110 of the sleeve 100. Here, the sleeve 100 may be formed of a polymer substrate.

The plurality of magnetic terminals 180 are formed on the upper side of the connector 110 of the sleeve 100 while they are separated from each other by predetermined intervals. Each of the magnetic terminals 180 is electrically connected to the connector 110 via wiring 150. The communication terminals 190 are formed around the magnetic terminals 180 while they are separated from each other by predetermined intervals. The plurality of communication terminals 190 are formed around the respective magnetic terminals 180 while they are separated from each other by predetermined intervals. Each of the communication terminals 190 is electrically connected to the connector 110 via wiring 150. When the sleeve 100 is mounted on the charging pad 200, the mobile terminal 10 and the charging pad 200 may perform preset communication using the communication terminals 190.

The charging pad 200 includes magnetic electrodes 280 (V+ and V−), and communication electrodes 290 (D+ and D−) that magnetically come in contact with the magnetic terminals 180 and communication terminals 190 of the sleeve 100. The charging pad 200 is configured to supply charging power to the magnetic terminals 180 using the magnetic electrodes 280, and to perform communication with the communication electrodes 290 through the communication terminals 190.

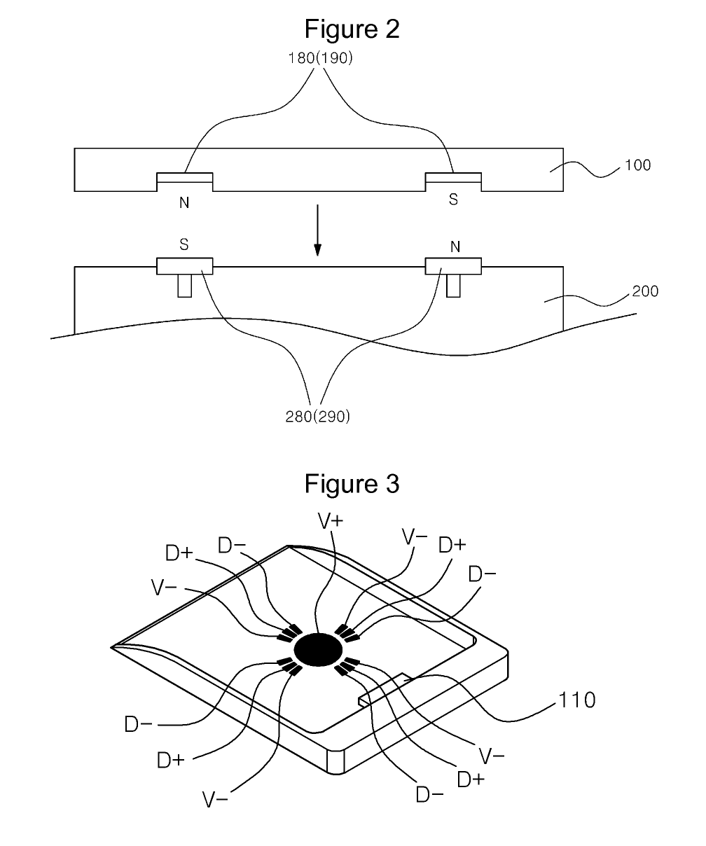

Here, the magnetic electrodes 280 of the charging pad 200 and the magnetic terminals 180 of the sleeve 100, which correspond to the magnetic electrodes 280, may be formed in a protruded and depressed configuration, as shown in FIG. 2. For example, the magnetic terminals 180 of the sleeve 100 may be depressed to the inside of the sleeve 100 by approximately 0.5 to 1.5 mm, and the magnetic electrodes 280 of the charging pad 200 may be protruded by approximately 0.5 to 1.5 mm. Here, the height of the protrusion of each of the magnetic electrodes 280 should be the same as or higher than the depth of the depression of each of the magnetic terminals 180.

Further, the plurality of magnetic terminals 180 and the plurality of magnetic electrodes 280 may be formed with different polarities for the purpose of directivity of the sleeve 100.

When any one of the magnetic terminals 180 of the sleeve 100 is the N pole, the remaining one may be the S pole, as shown in FIG. 2. It is apparent that, if any one of the magnetic electrodes 280 of the charging pad 200 is the S pole, the remaining one may be the N pole. Although all of the magnetic terminals 180, the communication terminals 190, the magnetic electrodes 280, and the communication electrodes 290 may be formed of a permanent magnet, they may be formed of any one selected from among a permanent magnet, a ferromagnetic substance, and a paramagnet material. For example, the magnetic terminals 180 and the communication terminals 190 may be formed of a permanent magnet and the magnetic electrodes 280 and the communication electrodes 290 may be formed of a paramagnet material or a ferromagnetic substance. Although not shown, the communication electrodes 290 of the charging pad 200 and the communication terminals 190 of the sleeve 100, which correspond to the communication terminals 290, may be formed as in FIG. 2.

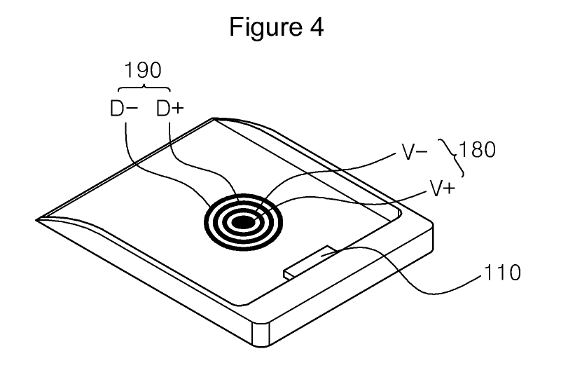

The magnetic terminals 180 and the communication terminals 190 which are formed on the sleeve 100 and the magnetic electrodes 280 and the communication electrodes 290, corresponding to the respective magnetic terminals 180 and the communication terminals 190, on the charging pad 200, may be arranged using various structures as well as shown in FIG. 1. For example, the magnetic terminals 180 (V+ and V−) and the communication terminals 190 (D+ and D−) may be arranged as in FIG. 3 or FIG. 4. It is apparent that the magnetic electrodes 280 and the communication electrodes 290 of the charging pad 200 may be arranged in the corresponding forms as in FIG. 3 or FIG. 4.

As shown in FIG. 3, magnetic terminals 180 and communication terminals 190 are formed in a radiation shape. The magnetic terminals 180 (V−) and the communication terminals 190 (D+ and D−) are arranged in all directions around a center magnetic terminal 180 (V+), while the magnetic terminals 180 (V−) and the communication terminals 190 (D+ and D−) are separated from each other. Since the terminals are formed in various directions, the sleeve 100 may be conveniently placed on the charging pad 200. That is, when the sleeve 100 is placed on the charging pad 200, the sleeve 100 can be placed at various angles.

In FIG. 4, the magnetic terminals 180 (V+ and V−) and the communication terminals 190 (D+ and D−) are formed in a concentric circle while they are separated from each other, and are characterized in that none of the terminals V+ to D− have directivity.

Since none of the terminals V+ to D− have directivity, it is very convenient when the sleeve 100 is placed on the charging pad 200. That is, the sleeve 100 can be mounted on the charging pad 200 in any direction when the sleeve 100 is placed on the charging pad 200. In addition, for the purpose of convenient mounting, the magnetic terminals 180 and the communication terminals 190 may be arranged using various structures.

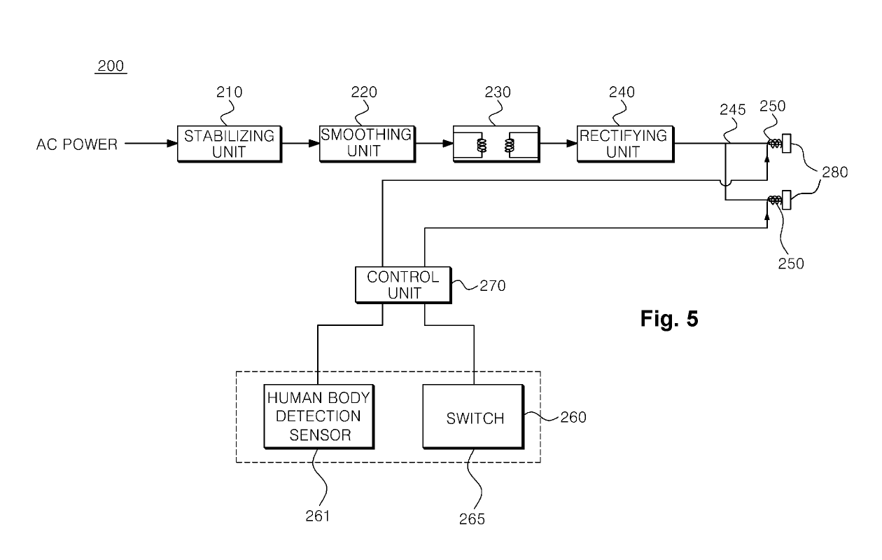

FIG. 5 is a diagram illustrating the detailed configuration of the charging pad according to an embodiment of the present invention. The charging pad 200 includes a stabilizing unit 210, a smoothing unit 220, a transformation unit 230, a rectifying unit 240, coils 250, an input unit 260, a control unit 270, and the magnetic electrodes 280.

The stabilizing unit 210 is configured to raise the common Alternating Current (AC) voltage received from the outside, for example, AC 110V or AC 220V, by 1.414 times, or to stabilize the received AC voltage.

The smoothing unit 220 smoothes the voltage output from the stabilizing unit 210 and outputs a voltage that is almost Direct Current (DC) voltage. That is, the smoothing unit 220 minimizes ripples included in the voltage output from the stabilizing unit 210, thereby reducing ripple noise.

The transformation unit 230 drops the level of the voltage output from the smoothing unit 220 to a desired voltage level and then outputs the resulting voltage. The transformation unit 230 includes a primary winding and a secondary winding. Noise that appears at the output terminal of the charging pad 200 may be decreased by appropriately adjusting the number of turns of the primary winding and the secondary winding. For example, noise that appears at the output terminal of the charging pad 200 is minimized when the number of turns of the primary winding is adjusted in the range of 83 to 90T (turns) and the number of turns of the secondary winding is adjusted in the range of 9 to 14T. The primary winding is wound with an insulating tape that is very thin. When the transformation unit 230 is configured as described above, the temperature characteristic and leakage inductance of the transformation unit 230 are improved and ripple noise is decreased.

The rectifying unit 240 rectifies voltage output from the secondary winding of the transformation unit 230, and outputs DC voltage using the magnetic electrodes 280.

Since the voltage generated at the secondary winding of the transformation unit 230 is near a square wave, the rectifying unit 240 rectifies the voltage and converts the voltage output from the charging pad to DC voltage. The rectifying unit 240 minimizes ripple noise using an inductor coil, thereby converting the output voltage to almost DC voltage.

The coils 250 operate as electromagnets that are wound on the respective magnetic electrodes 280, generate magnetic fields based on current being applied, and attenuate the magnetic forces of the magnetic electrodes 280. That is, current is applied to the coils 250 such that the magnetic forces of the magnetic electrodes 280 are attenuated.

The input unit 260 is configured to detect operational instructions received from the outside or an approaching human body, and to output a corresponding signal. The input unit 260 may include at least any one of a human body detection sensor 261 for detecting infrared rays coming from a human body and a mechanical switch 265 for outputting an operational signal based on the selection of a user.

The control unit 270 performs control in response to an instruction received from the input unit 260 such that current is applied to the coils 250 for a set time so that the magnetic forces of the magnetic electrodes 280 are attenuated or repulsive power is generated between the magnetic electrodes 280 and the magnetic terminals 180 of the sleeve 100, which respectively come in contact with the magnetic electrodes 280.

The coils 250 are wound on the magnetic electrodes 280 of the charging pad 200, so that the magnetic forces of the magnetic electrodes 280 are attenuated depending on magnetic fields generated by the coils 250 or magnetic forces are generated such that repulsive power is generated between the magnetic electrodes 280 and the magnetic terminals 180 of the sleeve 100, which respectively come into contact with the magnetic electrodes 280.

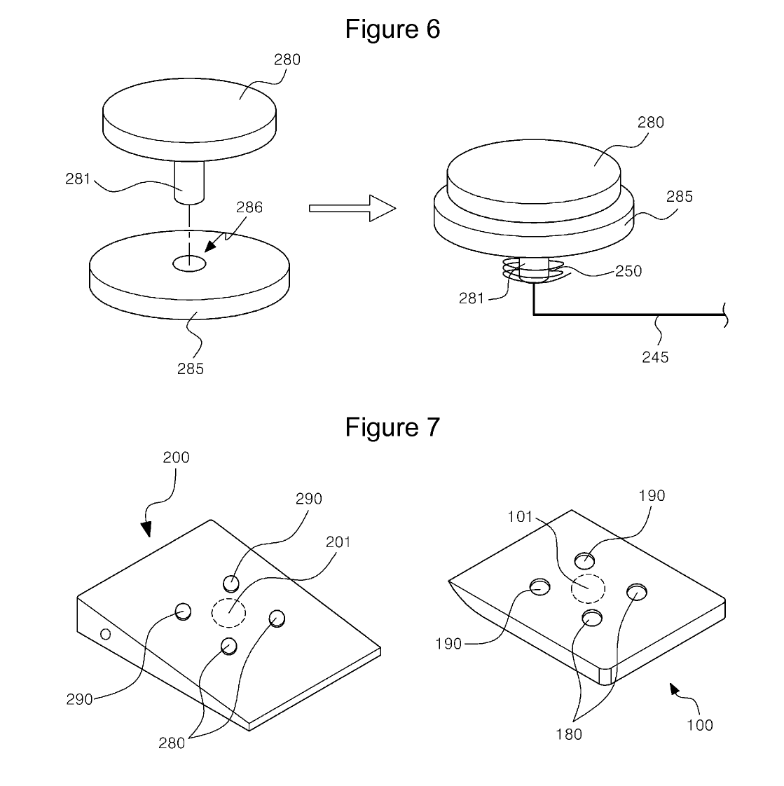

The above-described human body detection sensor 261 and coils 250 are devices used to prevent situation in which it is difficult to separate the sleeve 100 from the charging pad 200 because the strong magnetic forces between the sleeve 100 and the charging pad 200 are too strong. Each of the magnetic electrodes 280 may further include a subsidiary magnet 285 in order to increase the magnetic forces of the respective magnetic terminal 180 and the magnetic electrode 280, as shown in FIG. 6.

Here, as shown in the drawing, the subsidiary magnet 285 is formed in a donut configuration in which a through hole 286 is formed in the center of a circular plate, so that the pin 281 of the electrode 280 can be inserted into the through hole and fixed therein. If the subsidiary magnet 285 has an area which is wider than that of the electrode 280, the magnetic force of the electrode 280 can be increased. The subsidiary magnet 285 configured as described above can be applied to not only each of the magnetic electrodes 280 of the charging pad 200 but also to each of the magnetic terminals 180 of the sleeve 100.

It is apparent that, when the subsidiary magnet 285 is provided to the electrode 280 of the charging pad 200, the electrode 280 may be formed not of a magnet but of a magnetic material. That is, the electrode 280 installed on the charging pad 200 may be formed of a magnetic material, and the subsidiary magnet 285 can be formed to apply magnetic force to the magnetic material. When the electrode 280 is a magnetic material, the subsidiary magnet 285 and the coil 250 may be wound on the pin 281 of the electrode 280. Since the coils 250 operate under the control of the control unit 270 as shown in FIG. 3, the detailed description thereof will be omitted.

FIG. 7 is a view illustrating the appearance of a charging device using magnet electrodes according to another embodiment of the present invention. Unlike FIG. 1, reinforcement magnets 101 and 201 may be further installed in the respective sleeve 100 and charging pad 200 in addition to the magnetic terminals 180 and the magnetic electrodes 280 in order to increase adhesive force of each other.

A plurality of magnetic terminals 180 are separated by predetermined intervals and arranged on the upper side of the connector 110 of the sleeve 100. Each of the magnetic terminals 180 is electrically connected to the connector 110 using wiring.

The reinforcement magnet 101 may be provided in the sleeve 100 on the upper side of the plurality of magnetic terminals 180. Here, it is preferable that the reinforcement magnet 101 be arranged in the middle of the plurality of magnetic terminals 180 and communication terminals 190 for the purpose of stable adhesive force.

It is apparent that a reinforcement magnet 201 corresponding to the reinforcement magnet 101 of the sleeve 100 is installed in the charging pad 200.

There is no problem even if the reinforcement magnets 101 and 201 are not exposed to the outside but respectively are provided in the sleeve 100 and the charging pad 200.

A procedure for mounting the above-described charging device using magnetic electrodes 280 and a procedure for performing charging using the charging device will be described below.

The mobile terminal 10 is inserted into and mounted on the sleeve 100. Here, the charging terminal 15 of the mobile terminal 10 and the connector 110 of the sleeve 100 are coupled to each other and electrically connected to each other.

If the sleeve 100 is placed on the charging pad 200 in the above-described state, the magnetic terminals 180 are adhered to the magnetic electrodes 280 due to the magnetic forces between the magnetic electrodes 280 of the charging pad 200 and the magnetic terminals 180 of the sleeve 100.

Here, if the poles of the magnetic terminals 180 of the sleeve 100 are the S poles, the poles of the magnetic electrodes 280 of the charging pad 200 become the N poles.

However, the plurality of magnetic electrodes 280 may be formed of poles that are different from each other for the purpose of directivity of the sleeve 100. That is, the plurality of magnetic electrodes 280 of the charging pad 200 may be formed of poles that are different from each other, and directivity can be applied when the sleeve 100 is mounted on the charging pad 200 in such a way to differentiate the shapes or areas of the plurality of magnetic electrodes 280 formed on the charging pad 200 if necessary.

When the magnetic terminals 180 of the sleeve 100 are adhered to the respective magnetic electrodes 280 of the charging pad 200 as described above, the charging voltage of the charging pad 200 is supplied to the mobile terminal 10 mounted on the sleeve 100 using the magnetic electrodes 280 and the magnetic terminals 180, thereby charging a battery.

Although not shown in FIG. 5 in detail, the charging pad 200 may further include an indication Light Emitting Diode (LED) which displays the charging status of a battery.

If, when charging is performed, the hand of a user approaches the charging pad 200 or an instruction indicative of the removal of the sleeve 100 is received using a predetermined switch, the control unit 270 applies current to coils 250 wound on magnetic electrodes 280, so that the magnetic forces of the magnetic electrodes 280 are attenuated or the polarities of the magnetic electrodes 280 are changed, thereby removing the magnetic forces between the charging pad 200 and the sleeve 100. As described above, when a human body is detected or a relevant switch is turned on, the control unit 270 performs control such that the magnetic forces of the magnetic electrodes 280 are attenuated so that a user can easily separate the sleeve 100 from the charging pad 200. Here, when a human body is detected or a relevant switch is turned on, it is preferable that the control unit 270 apply current for a set time, for example, approximately several seconds.

As described above, the present invention uses a simple-structured charging manner in which magnetic electrodes are used, thereby rapidly charging a mobile terminal like an existing wired charger, and conveniently charging a mobile terminal like a wireless charger using a magnetic induction manner. Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A charging device using magnets, comprising:
a sleeve including a connector connected to a charging terminal of a mobile terminal, and a plurality of magnetic terminals connected to the connector; and a charging pad including magnetic electrodes which magnetically come into contact with the respective magnetic terminals of the sleeve, and supplying charging power to the magnetic terminals using the magnetic electrodes.

2. The charging device according to claim 1, further comprising:
a plurality of communication terminals provided around the magnetic terminals of the sleeve; and a plurality of communication electrodes provided on the charging pad such that the communication electrodes correspond to the respective communication terminals.

3. The charging device according to claim 1, wherein the magnetic electrodes of the charging pad are configured such that magnetic forces are attenuated due to magnetic fields of coils or such that repulsive forces are generated between the magnetic electrodes of the charging pad and the magnetic terminals of the sleeve which come into contact with the magnetic electrodes.

4. The charging device according to claim 1, wherein the charging pad further comprises: a transformation unit for dropping a level of an externally applied common Alternating Current (AC) voltage to a desired level; and a rectifying unit for rectifying voltage output from the transformation unit to Direct Current (DC) voltage, and outputting the DC voltage to the magnetic electrodes.

5. The charging device according to claim 1, wherein the charging pad further comprises: coils wound on respective magnetic electrodes, and configured to generate magnetic fields depending on current to be applied; an input unit configured to detect an operational instruction received from an outside or an approached human body, and to output a signal corresponding thereto; and a control unit configured to apply current to the coils for a set time based on the instruction received from the input unit such that magnetic forces of the magnetic electrodes are attenuated or that repulsive forces are generated between the magnetic electrodes of the charging pad and the magnetic terminals of the sleeve.

6. The charging device according to claim 5, wherein the input unit comprises at least any one of a human body detection sensor and a mechanical switch.

7. The charging device according to claim 1, wherein the magnetic electrodes of the charging pad and the corresponding magnetic terminals of the sleeve are formed in a protruded and depressed configuration.

8. The charging device according to claim 1, wherein the magnetic electrodes of the charging pad are formed with different polarities.

9. The charging device according to claim 1, wherein the charging pad further comprises subsidiary magnets which are coupled to the respective magnetic electrodes and configured to increase magnetic forces of the magnetic electrodes.

10. The charging device according to claim 1, further comprising:
a reinforcement magnet around the magnetic electrodes of the charging pad;
and a magnet configured to correspond to the reinforcement magnet, and installed in the sleeve, thereby increasing adhesive force of the sleeve.

11. The charging device according to claim 10, wherein the reinforcement magnet is installed in the charging pad.

12. A charging device using magnets, comprising:
a sleeve including a connector connected to a charging terminal of a mobile terminal, and a plurality of magnetic terminals connected to the connector; and a charging pad including magnetic material electrodes which magnetically come into contact with the respective magnetic terminals of the sleeve, and supplying charging power to the magnetic terminals using the magnetic material electrodes.

13. The charging device according to claim 12, further comprising:
a plurality of communication terminals provided around the magnetic terminals of the sleeve; and a plurality of communication electrodes provided on the charging pad such that the communication electrodes correspond to the respective communication terminals.

14. The charging device according to claim 12, further comprising magnets coupled to the magnetic material electrodes of the charging pad, and configured to apply magnetic forces to the magnetic material electrodes.

15. The charging device according to claim 12, wherein the magnetic material electrodes of the charging pad and the corresponding magnetic terminals of the sleeve are formed in a protruded and depressed configuration.
